(19) United States
(12) Patent Application Publication
(10) Pub. No.: US 2008/0266624 A1
(43) Pub. Date: Oct. 30, 2008

(54) HOLOGRAM RECORDING APPARATUS

(75) Inventor: Kazushi Uno, Kawasaki (JP)

Correspondence Address: GREER, BURNS & CRAIN, 300 S WACKER DR, 25TH FLOOR, CHICAGO, IL, 60606, US

(73) Assignee: FUJITSU LIMITED, Kawasaki-shi (JP)

(21) Appl. No.: 12/057,886

(22) Filed: Mar. 28, 2008

(30) Foreign Application Priority Data
Apr. 27, 2007 (JP) 2007-118264

(51) Int. Cl. G02B 5/32

(52) U.S. Cl. 359/21; 359/15

(57) ABSTRACT

A hologram recording apparatus for recording a hologram by dividing light from a light source into recording light and reference light through a spatial light modulator, and emitting the recording light and reference light through the same objective lens onto a hologram recording medium; wherein the spatial light modulator has a light modulating region including a plurality of pixels; the light modulating region is divided into a central pixel region where a part of the light from the light source is led to the objective lens as the recording light, and a peripheral pixel region where the rest or another part of the light is led to the objective lens as the reference light; and a plurality of pixels included in the peripheral pixel region includes larger pixels than a plurality of pixels included in the central pixel region.

### BACKGROUND OF THE INVENTION

1. Field of the Invention

The present invention relates to a hologram recording apparatus for recording a hologram in a so-called coaxial system.

2. Description of the Related Art

As a hitherto known hologram recording apparatus, an apparatus is disclosed in Japanese Laid-open Patent Publication No. 2006-113296. The hologram recording apparatus disclosed in the document is configured for recording a hologram in a hologram recording medium in a so-called coaxial system. In such a hologram recording apparatus of the coaxial system, light from a light source is converted into parallel light by a collimating lens, and then divided into recording light (signal light) and reference light through a spatial light modulator, further, the recording light and reference light are converged into the hologram recording medium through the same objective lens.

As for the spatial light modulator, a central pixel region is to be a region for producing the recording light, and a peripheral pixel region is to be a region for producing the reference light. In the central pixel region and the peripheral pixel region, a plurality of pixels are formed in a lattice-shape with a uniform pitch. As shown in FIG. 7, an objective lens 400 which is used for this type of coaxial system is arranged so that a numerical aperture (NA) is made relatively large so that an irradiated area on a hologram recording medium B becomes as small as possible from the aspect of enhancing recording density. In such an objective lens 400, for example, when recording light S and reference light R have approximately equal luminous flux widths W viewing the respective cross sections along their optical axes, the reference light R which has a large incident angle is difficult to be made to desirably interfere with the recording light S depending on the light intensity. In order to improve this, the peripheral pixel region for producing the reference light R in the spatial light modulator may be secured as large as possible to make the luminous flux width W of the reference light R larger.

### SUMMARY

However, according to the hitherto known hologram recording apparatus described above, when the peripheral pixel region in the spatial light modulator is enlarged, the central pixel region becomes relatively down-sized, thereby causing a decrease in the amount of recording information accordingly. Also, because the luminous flux width W of the reference light R becomes larger in addition to the incident angle of the reference light R being large, an area where the recording light S and the reference light R are not overlapped on the hologram recording medium B, that is an idle exposed area, becomes enlarged. Therefore, it has been difficult to satisfy both conditions of desirably making the recording light S and the reference light R interfere with each other and enhancing the recording density.

Accordingly, the present invention has been made under the aforementioned circumstances. The object of the present invention is to provide a hologram recording apparatus, capable of enhancing recording density while desirably making recording light and reference light interfered with each other.

According to one aspect of the present invention, a hologram recording apparatus for recording a hologram comprises a light source emitting a light, an objective lens and a spatial light modulator. The spatial light modulator comprises a light modulating region, which comprises a central pixel region being formed on the spatial light modulator and comprising a plurality of first pixels, and a peripheral region being formed so as to surround the central region and comprising a plurality of second pixels, where the plurality of second pixels including a pixel being larger than each of the first pixels. A first part of the light passed through the central pixel region and a second part of the light passed through the peripheral pixel region incident on the objective lens, wherein the hologram is recorded with the first and the second lights.

According to another aspect of the present invention, a hologram recording apparatus is a hologram recording apparatus for recording a hologram by dividing light from a light source into recording light and reference light through a spatial light modulator, and emitting the recording light and reference light through the same objective lens onto a hologram recording medium; wherein the spatial light modulator has a light modulating region including a plurality of pixels; the light modulating region is divided into a central pixel region where a part of the light from the light source is led to the objective lens as the recording light, and a peripheral pixel region where the rest or another part of the light is led to the objective lens as the reference light; and a plurality of pixels which are included in the peripheral pixel region includes larger pixels than a plurality of pixels which are included in the central pixel region.

Preferably, the peripheral pixel region is further divided into a plurality of regions, and the outer region includes the larger pixels in the regions.

Preferably, an average area of a plurality of pixels which are included in the peripheral pixel region is larger than an average area of a plurality of pixels which are included in the central pixel region.

Preferably, a light blocking region is provided between the central pixel region and the peripheral pixel region.

Preferably, the peripheral pixel region is formed in a concavo-convex shape so that a predetermined phase difference is produced between the adjacent pixels.

Preferably, the average pixel areas Ss and Sr satisfy the relationship Ss<Sr<6.25 Ss, assuming that Ss is the average pixel area of the central pixel region, and Sr is the average pixel area of the peripheral pixel region.

Other features and advantages of the present invention will become apparent from the following detailed description taken in conjunction with the accompanying drawings.

### BRIEF DESCRIPTION OF THE DRAWINGS

FIG. 1 is a schematic overall configuration figure showing an embodiment of a hologram recording apparatus according to the present invention;

FIG. 2 is a schematic configuration figure showing an essential part of the hologram recording apparatus shown in FIG. 1;

FIG. 3 is a schematic figure for describing the operation function of the hologram recording apparatus shown in FIG. 1;

FIG. 4 is an explanatory figure for describing the hologram recording apparatus shown in FIG. 1 using an equivalent optical system;

FIG. 5 is an explanatory figure for describing results of an experiment using the optical system in FIG. 4;

FIG. 6 is a schematic configuration figure of an essential part of the hologram recording apparatus showing another embodiment according to the present invention; and

FIG. 7 is a schematic figure for describing the operation function of a hitherto known hologram recording apparatus.

### DESCRIPTION OF THE PREFERRED EMBODIMENTS

Hereinafter, a preferred embodiment of the present invention will be specifically described with reference to the drawings.

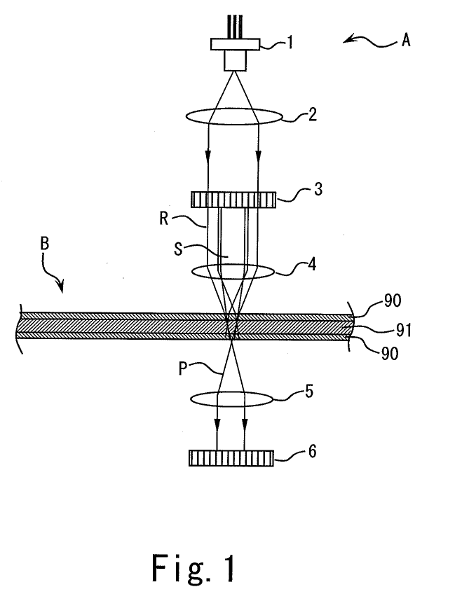

FIGS. 1 to 3 show an embodiment of a hologram recording apparatus according to the present invention. As shown in FIG. 1, a hologram recording apparatus A is configured to record a hologram in a hologram recording medium B in a so-called coaxial system. The hologram recording apparatus A includes: a light source 1, a collimating lens 2, a spatial light modulator 3, a recording objective lens 4, a reproducing objective lens 5, and an image pickup device 6. The hologram recording medium B includes: protective layers 90 forming obverse-reverse both surfaces, and a recording layer 91 which is formed between the protective layers. On the recording layer 91, the hologram is recorded by making recording light S and reference light R interfere with each other. At the time of reproducing, the reference light R interferes with the hologram which is recorded on the recording layer 91 to produce reproducing light P, and the reproducing light P is to be received by an image pickup device 6 disposed on the reverse side of the hologram recording medium B. Incidentally, optical components which are disposed between the light source 1 and the recording objective lens 4, and between the reproducing objective lens 5 and the image pickup device 6, for example a zoom lens and an aperture, are omitted for convenience.

The light source 1 includes, for example, a semiconductor laser device. The light source 1 outputs relatively narrow-spectrum coherent laser light at the times of recording and reproducing.

The collimating lens 2 converts the laser light outputted from the light source 1 into parallel light. The laser light, which has become parallel light, enters a spatial light modulator 3.

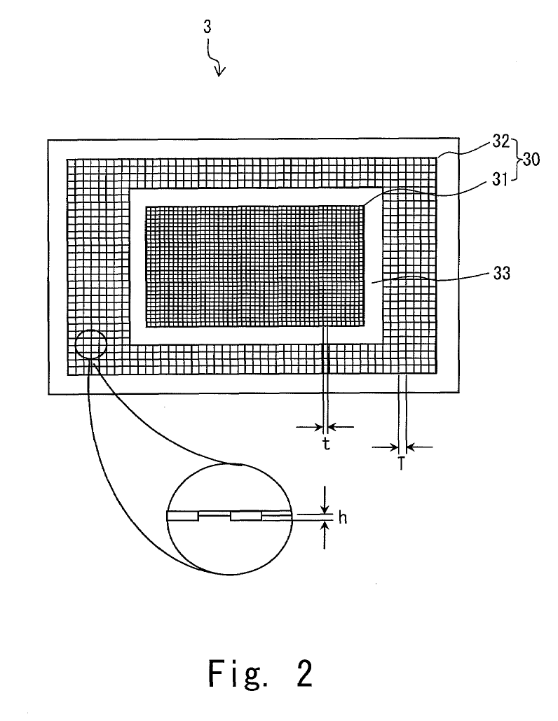

The spatial light modulator 3 includes, for example, a transmissive liquid crystal panel. The spatial light modulator 3 has, as shown in FIG. 2, a light modulating region 30 including a lot of pixels. The light modulating region 30 is divided into a central pixel region 31 through which a part of the laser light entered as the parallel light is modulated into the recording light S of a pixel pattern according to the recording information, and a peripheral pixel region 32 through which the rest part of the laser light is outputted as the reference light R. Between the central pixel region 31 and the peripheral pixel region 32, a light blocking region 33 is provided so as to block the laser light and form a boundary. The pixel pitch T of the peripheral pixel region 32 is physically larger than the pixel pitch t of the central pixel region 31. That is, the pixels in the peripheral pixel region 32 are formed to be larger than those in the central pixel region 31. The pixels in the peripheral pixel region 32 are, as shown in the circle of the figure, formed in a concavo-convex shape so that a phase difference equivalent to a half-wavelength is produced between the adjacent pixels. For example, a high-low difference h between the adjacent pixels becomes approximately λ/2, assuming that λ is the wavelength of the laser light. The recording light S and the reference light R outputted from the spatial light modulator 3 described above are emitted onto the hologram recording medium B through the same objective lens 4 at the time of recording. In case of reproducing, every pixel in the central pixel region 31 enters an OFF state through which no light is transmitted, whereby only the reference light S is to be emitted through the peripheral pixel region 32. Additionally, as for the pixels in the central pixel region 31, although not particularly shown in the figure, they may also be formed to be in a concavo-convex shape.

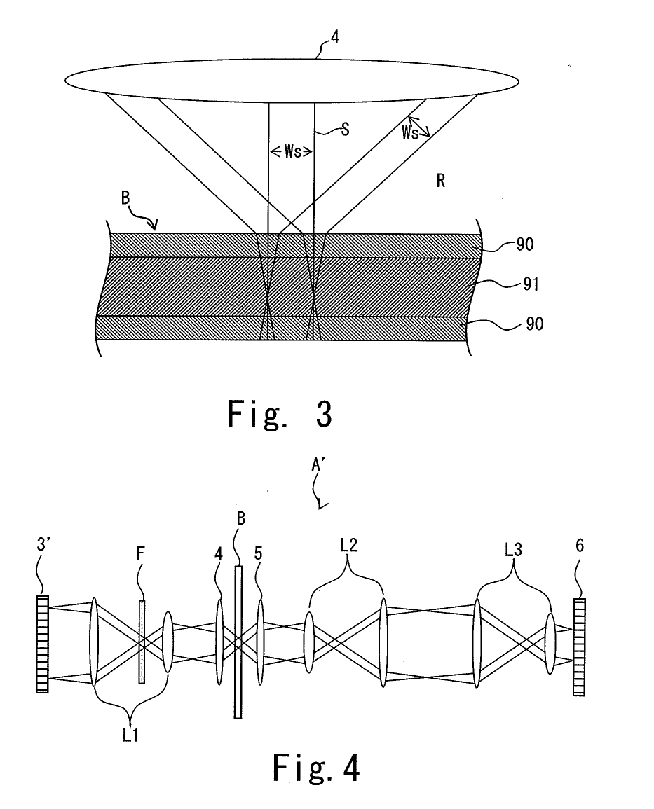

As shown in FIG. 3, the recording objective lens 4 converges the recording light S and the reference light R into the recording layer 91 of the hologram recording medium B. The objective lens 4 is designed so that the irradiated area becomes as small as possible, for example, the numerical aperture becomes relatively large, approximately 0.7. The recording light S is emitted onto the hologram recording medium B through the vicinity of the central portion of the objective lens 4. Therefore, the incident angle of the recording light S is relatively small. On the other hand, the reference light R is emitted through the vicinity of the peripheral portion of the objective lens 4, therefore, the incident angle is to be relatively large. For example, the incident angle of the reference light R becomes approximately forty-five degrees at maximum.

The reproducing objective lens 5 has basically the same optical properties as the recording objective lens 4, and leads the reproducing light P produced at the time of producing to the image pickup device 6.

The image pickup device 6 includes, for example, a CCD area sensor or a CMOS area sensor. The image pickup device 6 converts the received reproducing light P into a digital signal, and reads out two-dimensional information recorded as a hologram in the hologram recording medium B.

Next, functions of the hologram recording apparatus A will be described.

At the time of recording, laser light from the light source 1 enters the spatial light modulator 3 through the collimating lens 2. In the central pixel region 31 of the spatial light modulator 3, each pixel enters ON-OFF state according to the recording information, whereby the recording light S including a predetermined pixel pattern is produced.

On the other hand, in the peripheral pixel region 32 of the spatial light modulator 3, predetermined pixels between the pixels having a phase difference equivalent to 0 and the pixels having a phase difference equivalent to π are brought into an ON state, whereby a reference light R including a predetermined phase pattern is produced. An example of the predetermined phase pattern is, a pattern according to the determinant of the Walsh-Hadamard Transform. By varying such a phase pattern, so-called multi-phase recording is performable.

In this regard, the reference light R is led to the objective lens 4 as diffracted light according to the size of pixels (pixel pitch T) of the peripheral pixel region 32, and the recording light S is led to the objective lens 4 as diffracted light according to the size of pixels (pixel pitch t) of the central pixel region 31. As for the diffracted light from each of the pixels, the diffraction angle becomes smaller as the pixel pitch becomes larger, whereby the luminous flux density is to be large. Therefore, the reference light R is emitted onto the hologram recording medium B with a large incident angle compared with the recording light S, which can be made to interfere with the reference light R with a certain level of light intensity.

This means a luminous flux width Wr of the reference light R in relation to the luminous flux width Ws of the recording light S can be smaller than ever before. By making the luminous flux width Wr of the reference light R smaller as described above, an idle exposed area where the recording light S and the reference light R are not overlapped in the hologram recording medium B becomes smaller. Thus, the idle exposed area and the overall irradiated area become smaller, and consequently, the recording density of the hologram can be enhanced.

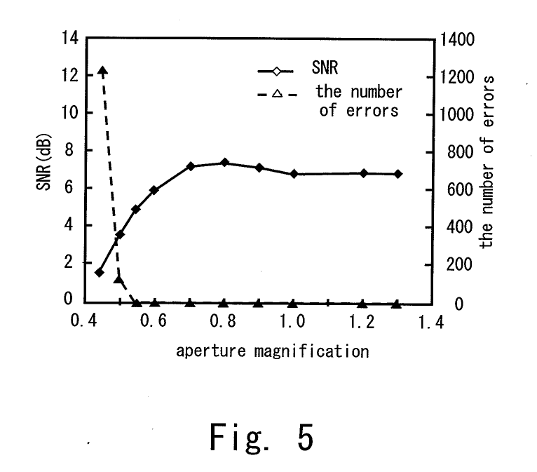

FIG. 4 shows an optical system equivalent to the hologram recording apparatus A according to the embodiment, and FIG. 5 shows results of an experiment using the optical system in FIG. 4.

An optical system A′ shown in FIG. 4 includes: a spatial light modulator 3′ in which every pixel is formed in a uniform size, and an aperture filter F which is disposed between the spatial light modulator 3′ and a recording objective lens 4. Between the spatial light modulator 3′ and the objective lens 4, a lens group L1 is disposed so as to arrange the aperture filter F thereamong, and also, between a reproducing objective lens 5 and an image pickup device 6, lens groups L2 and L3 are disposed.

As the configuration of the embodiment, making the pixels in the peripheral pixel region 32 larger than those in the central pixel region 31 of the spatial light modulator 3 produces optically the same functional effects as making the aperture magnification of the aperture filter F smaller in the optical system A′. In this regard, distance between a zero-order diffracted light and first-order diffracted light according to the aperture filter F is expressed by λf/T, where assuming that X is the aperture radius of the aperture filter F, λ is the wavelength of the laser light, f is the focal distance of the lens group L1 (equivalent to the distance between the spatial light modulator 3′ and the lens group L1), and T is a pixel pitch in the spatial light modulator 3′. The aperture magnification is a ratio of the aperture radius X to λf/T which is expressed by magnification. The aperture magnification can be assumed to be the ratio of the pixel pitch t of the central pixel region 31 to the pixel pitch T of the peripheral pixel region 32.

In such an optical system A′, an experiment in which the aperture magnification is varied has been carried out. It is assumed that the number of pixels in the spatial light modulator 3′ is 40000, and a reproducing signal can be received from each pixel. As the results of the experiment shown in FIG. 5, when the aperture magnification is higher than or equal to 0.4, the SNR of the reproducing signals outputted from the image pickup device 6 is within the practically reproducible level, and the number of errors is also within the allowable range. In other words, an aperture magnification lower than 0.4 exceeds the resolution limit. Based on the aspect described above, as for the configuration of the embodiment, the ratio (t/T) of the pixel pitch t in the central pixel region 31 to the pixel pitch T in the peripheral pixel region 32 must be higher than or equal to 0.4. To consider replacing this with a pixel area, the average pixel areas Ss and Sr must satisfy the relationship Ss<Sr<Ss/0.4/0.4 (6.25 Ss), assuming that Ss is the average pixel area of the central pixel region 31, and Sr is the average pixel area of the peripheral pixel region 32. Therefore, as for the configuration of the embodiment, while the average pixel area Sr of the peripheral pixel region 32 is larger than the average pixel area Ss of the central pixel region 31, the average pixel area Sr is set so as not to be more than or equal to 6.25 times the average pixel area Ss, from the resolution limit at the time of reproduction.

Thus, according to the hologram recording apparatus A of the embodiment, while the incident angle of the reference light R becomes relatively large by the objective lens 4 suitable for a coaxial system, the light intensity of the reference light R can be maintained at a predetermined level, whereby the recording light S and the reference light R can be made to desirably interfere with each other, and consequently, the hologram can be recorded at a high resolution.

Also, while the light intensity of the reference light R is to be at a predetermined level, the idle exposed area can be made smaller than ever before, whereby the irradiated area for recording the hologram can be made as small as possible, and consequently, the recording density of the hologram can be enhanced.

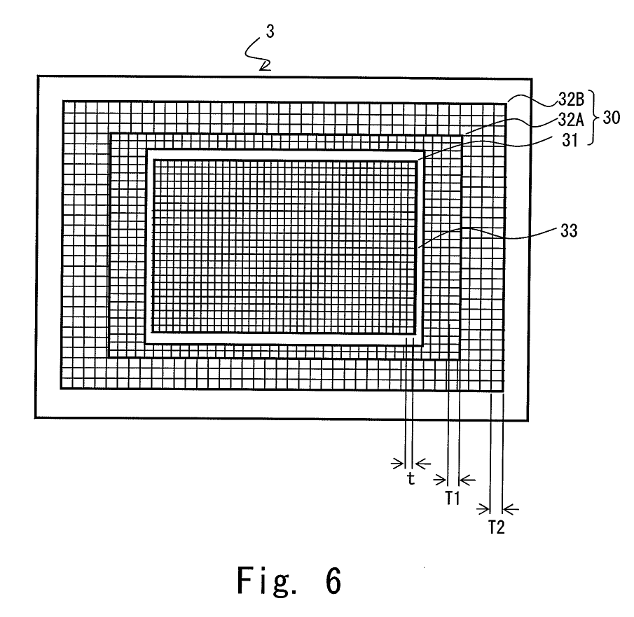

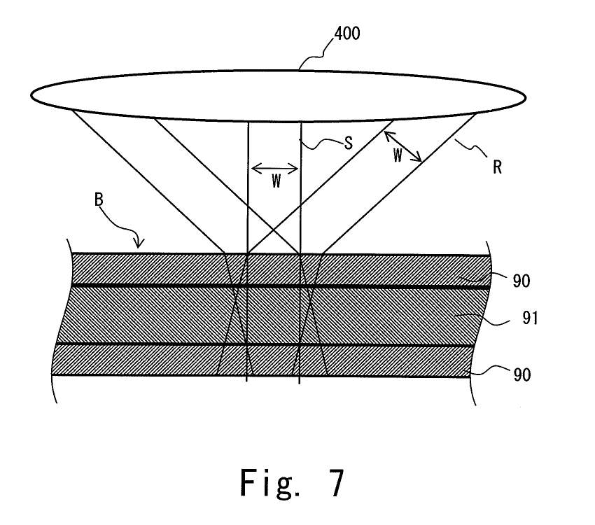

FIG. 6 shows another embodiment of the hologram recording apparatus according to the present invention. Incidentally, the same reference numerals are used for components identical or similar to those of the embodiment described above. The components not shown in the figure are identical to those of the above embodiment; therefore explanation thereof will be omitted by applying the same reference numerals thereto.

As for a spatial light modulator 3 shown in FIG. 6, a peripheral pixel region is divided into a first circular region 32A on the inside and a second circular region 32B on the outside. Pixel pitches T1 and T2 of the first circular region 32A and the second circular region 32B are both larger than a pixel pitch t of a central pixel region 31. The pixel pitch T2 of the second circular region 32B is formed to be larger than the pixel pitch T1 of the first circular region 32A. Further, from the aspect of the aforementioned resolution limit, also as the configuration of the embodiment, the largest average pixel area Sr of the peripheral pixel region 32B is set so as not to be more than or equal to 6.25 times the average pixel area Ss of the central pixel region 31.

According to the hologram recording apparatus with such a configuration, the second circular region 32B on the outside becoming a larger incident angle is formed so as to be larger in pixel pitch T2, whereby, while the light intensity of the reference light R from the second circular region 32B can be maintained at a predetermined level, its luminous flux width can be made further smaller. Therefore, the idle exposed area can be made further smaller.

Still further, because incident angles between the reference light R from the first circular region 32A and the reference light R from the second circular region 32B are somewhat different, so-called multi-angle recording is performable by alternately controlling the first and second circular regions 32A and 32B respectively, thus the multiplicity of the hologram can be greater and the recording density can be enhanced.

However, the present invention is not limited to the above-described embodiments.

For example, the first circular region and the second circular region may be approximately equal in pixel pitch and a light blocking region may be provided therebetween. Also, no light blocking region may be provided between the first circular region and the second circular region, or between the central pixel region and the peripheral pixel region.

What is claimed is:

1. A hologram recording apparatus for recording a hologram comprising:
a light source emitting a light;
an objective lens; and
a spatial light modulator comprising a light modulating region, the light modulating region including:
a central pixel region being formed on the spatial light modulator and comprising a plurality of first pixels; and
a peripheral region being formed on a part surrounding the central region and having a plurality of second pixels, the plurality of second pixels including a pixel being larger than each of the first pixels,
wherein a first part of the light passed through the central pixel region and a second part of the light passed through the peripheral pixel region are incident on the objective lens,
wherein the hologram is recorded with the first part and the second part of lights.

2. A hologram recording apparatus according to claim 1, each of the pixels are electrically controlled so as to become an optical transparent state or opaque.

3. A hologram recording apparatus for recording a hologram comprising:
a light source;
an objective lens; and
a spatial light modulator including a light modulating region, the light modulating region including a plurality of pixels, the light modulating region comprising a central pixel region and a peripheral pixel region, the central pixel region being allowed to lead a part of the light from the light source to the objective lens as the recording light, the peripheral pixel region being allowed to lead a rest of the light to the objective lens as the reference light, the plurality of pixels included within the peripheral pixel region being including a larger pixel than each of the plurality of pixels included within the central pixel region,
wherein a light from the light source is divided into a recording light and a reference light through the spatial light modulator, and the recording and reference lights are emitted through an objective lens onto a hologram recording medium for recording the hologram

4. A hologram recording apparatus according to claim 3, wherein the peripheral pixel region is further divided into a plurality of regions, and an outer region includes a larger pixel than a pixel in an inner region.

5. A hologram recording apparatus according to claim 4, wherein an average area of the plurality of pixels included within the peripheral pixel region is larger than an average area of the plurality of pixels included within the central pixel region.

6. A hologram recording apparatus according to claim 1, wherein a light blocking region is provided between the central pixel region and the peripheral pixel region.

7. A hologram recording apparatus according to claim 1, wherein the peripheral pixel region is formed in a concavo-convex shape so that a predetermined phase difference is produced between the adjacent pixels.

8. A hologram recording apparatus according to claim 1, wherein an average pixel areas Ss and Sr satisfy the relationship Ss<Sr<6.25 Ss, where Ss is an average pixel area of the central pixel region, and Sr is an average pixel area of the peripheral pixel region.
